(19) United States
(12) Patent Application Publication
(10) Pub. No.: US 2006/0226957 A1
(43) Pub. Date: Oct. 12, 2006

(54) HEALTH CARE OPERATING SYSTEM WITH RADIO FREQUENCY INFORMATION TRANSFER

(76) Inventors: Ronald H. Miller, Westland, MI (US); Hanaan Elmessiri, Inkster, MI (US); Scott A. Dulchavsky, Grosse Pointe Park, MI (US); Ilan S. Rubinfeld, Ann Arbor, MI (US); Mark A. Kelley, Bloomfield Hills, MI (US)

Correspondence Address: ARTZ & ARTZ, P.C., 28333 TELEGRAPH RD., SUITE 250, SOUTHFIELD, MI, 48034, US

(21) Appl. No.: 11/307,536

(22) Filed: Feb. 11, 2006

Related U.S. Application Data
(63) Continuation-in-part of application No. 10/904,530, filed on Nov. 15, 2004.
(60) Provisional application No. 60/652,118, filed on Feb. 11, 2005.

(51) Int. Cl. G08B 5/22

(52) U.S. Cl. 340/286.07

(57) ABSTRACT

A health care operating system (10) includes multiple health care center objects (44). Smart devices (42) are coupled to the health care center objects (44) and include body internal control circuits (64, 70, 134). A database (20) stores information related to the health care center objects (44). A server (18) is coupled to the database (20). Multiple controllers (46, 156, 158, 314, 320, 353, 360) are coupled to the server (18) and write and/or read the information to and from the smart devices (42) utilizing electromagnetic induction. A health care center network (10) also includes the health care center objects (44) and the smart devices (42). The smart devices (42) inductively transmit identification signals. The database (20) stores the information. The controllers (46, 156, 158, 314, 320, 353, 360) within multiple facilities (172, 174, 342, 344, 346, 348, 350) communicate with the server (18) in response to the identification signals.

### RELATED APPLICATION

The present application is related to U.S. Provisional Application 60/652,118 entitled “HEALTH CARE OPERATING SYSTEM WITH RADIO FREQUENCY INFORMATION TRANSFER” filed on Feb. 11, 2005, which is incorporated by reference herein. The present application is also a continuation-in-part of U.S. patent application Ser. No. 10/904,530 filed on Nov. 15, 2004, entitled “SMART SURGICAL DEVICE OPERATING SYSTEM WITH RADIO FREQUENCY IDENTIFICATION”, which is incorporated by reference herein.

### BACKGROUND OF THE INVENTION

Surgical fluid absorbing apparatuses as well as other surgical apparatuses are used throughout an operation on a patient to aid in the facilitation of an operating procedure. Fluid absorbing apparatuses are utilized to absorb various fluids within the patient. There are various types of surgical fluid absorbing apparatuses, which can be positioned under organs deep inside a body cavity, depending upon the nature of the operation. It can be difficult to locate the various absorbing apparatuses upon completion of an operation. Difficulty in detecting the absorbing apparatuses is dependent upon the absorbing apparatus type, the location of use, and other issues associated with the operation. It is desirable to account for and remove all fluid absorbing apparatuses from within a patient upon completion of an operation.

Currently, to account for all of the absorbing apparatuses used during an operation, as each absorbing apparatus pack is opened, a nursing staff manually counts the absorbing apparatuses and hands them individually to a surgeon. As the absorbing apparatuses are used, disposed of, and new absorbing apparatuses are placed inside a body, the nursing staff tracks the total number of absorbing apparatuses used. At the end of an operation, the number of used absorbing apparatuses is compared to the number of absorbing apparatuses provided to the surgeon. When there is not a one-to-one correlation in the number used and the number of removed fluid absorbing apparatuses, time is spent to account for this discrepancy and search for the missing fluid absorbing apparatuses.

Another technique performed to account for the fluid absorbing apparatuses utilized during an operating procedure includes the use of a plastic binning process whereby five used absorbing apparatuses at a time are placed in compartmentalized plastic slots, similar to the slots of a shoe garment bag. The absorbing apparatuses are then counted and an absorbing apparatus status is determined.

A third technique that has also been performed to account for absorbing apparatuses is the use of x-ray detection. When there is a discrepancy between the number of used absorbing apparatuses and the number of removed absorbing apparatuses, surgeons may physically search the body cavity and when necessary perform an x-ray on the patient to detect the missing fluid absorbing apparatuses. Current fluid absorbing apparatuses have a radio opaque strip for identification, which is detectable and thus locatable in an x-ray.

The above-stated techniques may all be utilized during an operation. However, the locating and accounting for of absorbing apparatuses, as well as other surgical apparatuses, can be timely and costly. In general, every minute in an operating room is costly. Thus, there exists a need for an improved technique of accounting for surgical apparatuses used during an operating procedure.

In addition, to the tracking and accounting of surgical apparatuses during a surgery several other medical facility trackings and accountings, as well as identifications, are desired. For example, there is a desire to efficiently track and identify patients and to have “On-the-Spot” readily available access to patient medical histories including illnesses, medications, allergies, surgeries, recent diagnoses, scheduled surgeries, and other patient related information. Such information is not always readily available, easily accessible, or accurate especially when a patient is transferred between rooms, medical facility departments, and/or medical facilities. As another example, it is also desirous to track patient related biomaterials and medicines. As well, it is also desirable to track other medical facility materials, stock items, equipment, instrumentation, beds/gurneys, food and beverage items, and other items located within a medical facility.

### SUMMARY OF THE INVENTION

One embodiment of the present invention provides a health care operating system that includes multiple health care center objects. Smart devices are attached to the health care center objects and include body internal control circuits. A database stores information related to the health care center objects. A server is coupled to the database. Multiple controllers are coupled to the server and write and/or read the information to and from the smart devices utilizing electromagnetic induction.

Another embodiment of the present invention provides a health care center network that includes health care center objects and smart devices. The smart devices are attached to the objects and inductively transmit identification signals. A database stores the information. A common server is coupled to the database. Controllers within multiple facilities communicate with the common server in response to the identification signals.

The embodiments of the present invention provide several advantages. One such advantage is a health care operating system and network that incorporates smart devices on various health care center objects, which allows for the real time, quick, and easy detecting, tracking, identifying, accounting, and monitoring of the objects and any related information. This allows for efficient assessing of the information. Also, the stated system and network allows for the maintaining of appropriate amounts and levels of the stated objects using “just-in-time” ordering and delivery techniques. Such maintenance prevents overstocking and thus reduces costs associated therewith.

Another advantage is a health care operating system and network that, in addition to that stated above, utilizes common servers and databases between multiple facilities including multiple health care centers. This allows for real time supply and inventory tracking, patient tracking, and diagnosis, treatment, and procedure updating and alerting, as well as other various advantageous information storing, accessing, and transmitting features that will become more apparent in view of the below provided description.

Yet another advantage provided by an embodiment of the present invention is a surgical device detection system that detects surgical apparatuses within a body. The system allows for the communication and/or detection of surgical devices without the need for a physical body cavity search or the need for an x-ray.

Still another advantage provided by an embodiment of the present invention is a surgical device accounting network that allows for a centralized accounting of surgical devices utilized within multiple hospitals and operating rooms therein.

The present invention itself, together with attendant advantages, will be best understood by reference to the following detailed description, taken in conjunction with the accompanying figures.

### BRIEF DESCRIPTION OF THE DRAWING

For a more complete understanding of this invention reference should now be had to the embodiments illustrated in greater detail in the accompanying figures and described below by way of examples of the invention wherein:

FIG. 1 is a block diagrammatic view of a health care operating system and network 10 in accordance with an embodiment of the present invention.

FIG. 2 is a block diagrammatic view of a sample generic smart device sub-system in accordance with an embodiment of the present invention.

FIG. 3A is a front view of a smart tag as applied to an interior side of a patient identification bracelet in accordance with an embodiment of the present invention.

FIG. 3B is a front perspective view of a smart tag as applied to an exterior side of a patient identification bracelet in accordance with an embodiment of the present invention.

FIG. 4A is a perspective view of a smart label in accordance with an embodiment of the present invention.

FIG. 4B is a side view of the smart label of FIG. 4A.

FIG. 5 is a close-up perspective view of a smart label on a vacutainer in accordance with an embodiment of the present invention.

FIG. 6 is a perspective view of a container having a smart label in accordance with another embodiment of the present invention.

FIG. 7A is a perspective side view of a specimen container having a smart label attached to the lid of the container in accordance with another embodiment of the present invention.

FIG. 7B is a perspective top view of the specimen container of FIG. 7A.

FIG. 8 is a front view of a towel container having a smart label attached thereon and in accordance with another embodiment of the present invention.

FIG. 9A is a perspective view of a specimen trap container having a smart label attached thereon and in accordance with another embodiment of the present invention.

FIG. 9B is a perspective view of a culture swab container having a smart label attached thereon and in accordance with another embodiment of the present invention.

FIG. 10A is a side view of a pair of pliers that has a micro RFID label in accordance with another embodiment of the present invention.

FIG. 10B is a side view of a pair of tweezers that has an RFID label in accordance with another embodiment of the present invention.

FIG. 11 is a block diagrammatic view of a smart fluid absorbing device for use during an operating procedure in accordance with an embodiment of the present invention.

FIG. 12A is a block diagrammatic view of a smart fluid absorbing device detection and accounting system utilizing serially coupled transponder antennas in accordance with an embodiment of the present invention.

FIG. 12B is a block diagrammatic view of a smart fluid absorbing device detection and accounting system utilizing wireless transponder antennas in accordance with an embodiment of the present invention.

FIG. 13 is a block diagrammatic view of surgical fluid absorbing apparatus accounting network in accordance with an embodiment of the present invention.

FIG. 14 is a logic flow diagram illustrating a method of accounting for surgical fluid absorbing apparatuses used during an operating procedure in accordance with an embodiment of the present invention.

FIG. 15 is a block diagrammatic view illustrating transitions of smart surgical fluid absorbing apparatuses before use during an operating procedure in accordance with an embodiment of the present invention.

FIG. 16 is a logic flow diagram illustrating a method of detecting surgical fluid absorbing apparatuses within a body cavity in accordance with an embodiment of the present invention.

FIG. 17 is a block diagrammatic view of a sample operating room infrastructure in accordance with an embodiment of the present invention.

FIG. 18 is a block diagrammatic view of a sample health care center infrastructure in accordance with an embodiment of the present invention.

FIG. 19 is a block diagrammatic view of a sample inventory infrastructure in accordance with an embodiment of the present invention.

### DESCRIPTION OF THE INVENTION

In the following figures, the same reference numerals will be used to refer to the same components. While the present invention is described with respect to a system and method of detecting and accounting for surgical apparatuses used during an operating procedure, the present invention may be adapted to be used in other similar applications where such accounting is desired.

In the following description, various operating parameters and components are described for one constructed embodiment. These specific parameters and components are included as examples and are not meant to be limiting.

Also, in the following description the term “health care center object” or “health care center object” may include or be in the form of patients, surgical apparatuses, absorbing apparatuses, tools, equipment, beddings, patient clothing, food and beverage containers, medicine containers, biomaterial containers, supply and inventory containers, and various other health care center objects known in the art. A health care center object may be animate or inanimate. A health care center object may be utilized before, during, or after a surgery or may be non-surgical related.

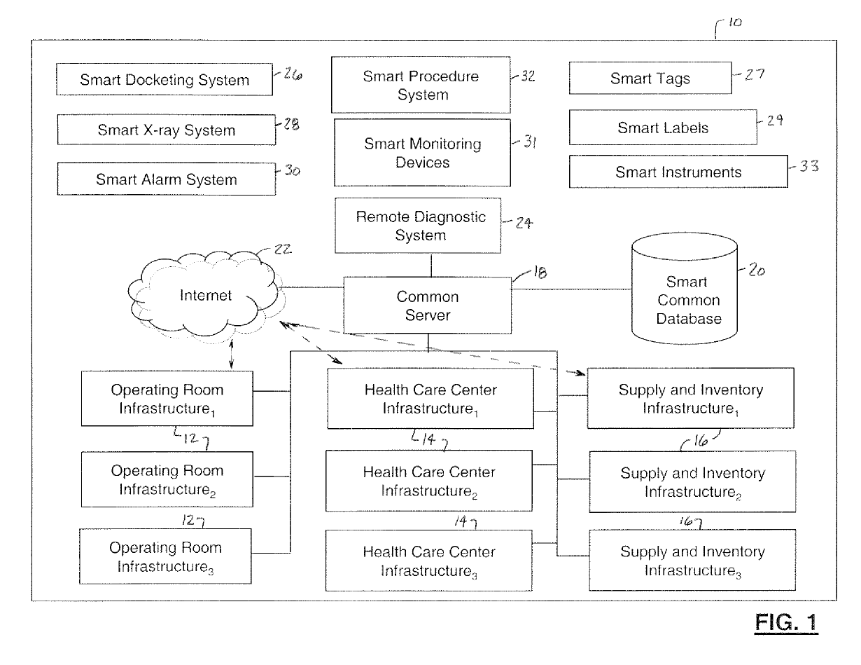

Referring now to FIG. 1, a block diagrammatic view of a health care operating system and network 10 is shown. The health care operating system 10 includes multiple sub-systems each of which incorporating radio frequency information transfer. The radio frequency information transfer includes but is not limited to identification information, location information, background/history information, quantity information, as well as other information that is described in more detail below and would become apparent in view of the following description. The stated information may be associated with any and all animate and inanimate objects contained within a medical facility. This also will become more apparent in view of the below description.

The health care operating system 10 includes one or more operating room infrastructures 12, health care center infrastructures 14, and supply and inventory infrastructures 16. Each of the infrastructures 12, 14, and 16 is in communication with a common server 18 and common database 20 or has a server or database that contains the same or similar information as in the common server 18 and common database 20. This communication may be wired or wireless communication, communication via powerlines, communication via the Internet 22, via satellite, or via some other known communication transport or network known in the art. Communication signals may be transmitted at various frequencies and on the same line as a power signal, such as a traditional 60 Hz power signal. Of course, other transmission techniques known in the art may be utilized. When more than one server and/or database are utilized, communication may be performed therebetween for continuous updating of data and information. Although the infrastructures 12, 14, and 16 are shown as individual entities, they are not mutually exclusive. The infrastructures 12, 14, and 16 share various systems, devices, components, health care center areas, and other items, which will also become more apparent in view of the following description.

A remote diagnostic system 24 may be coupled to or in communication with the common server 18 or the like. The remote diagnostic system 24 ensures that the various sub-systems of the health care system 10 function reliably. The remote diagnostic system 24 allows for remote administration of each of the infrastructures 12, 14, and 16. Remote administration provides a reliable real time technique for the management and accountability of smart devices. The diagnostic system 24 may also enable routine software upgrades and system performance enhancements. A technician may remotely access the health care system 10 and determine the current status of any sub-systems or smart devices thereof. The remote diagnostic system 24 may be in direct communication with the server 18, as shown, or may be in communication via the Internet 22. In another embodiment, the smart devices are active and transmit signals without reception of a request signal and/or reception of electromagnetic waves. The smart devices may continuously or periodically transmit signals for pickup by a controller/scanner or monitoring device or station.

The following description is partitioned according to individual sub-systems, which are part of multiple testing or operating phases of the health care system 10. These sub-systems are interrelated and are not all inclusive of the various facets of the overall health care operating system 10. Although three phases are primarily described herein with respect to a patient, one skilled in the art may envision such phases divided into multiple phases and/or the incorporation of additional phases. Also, the three phases and/or other phases may apply to other health care center objects than those specifically described. The first phase generally includes the admittance and registration of a patient, as well as the identification and association of biomaterials, medicines, and other health care center objects that can be related to that patient at that time. The second phase generally includes the testing and recording of the patient and any associated biomaterials to determine a diagnosis and a proper treatment or procedure. The third phase generally includes the performing of the treatment or procedure.

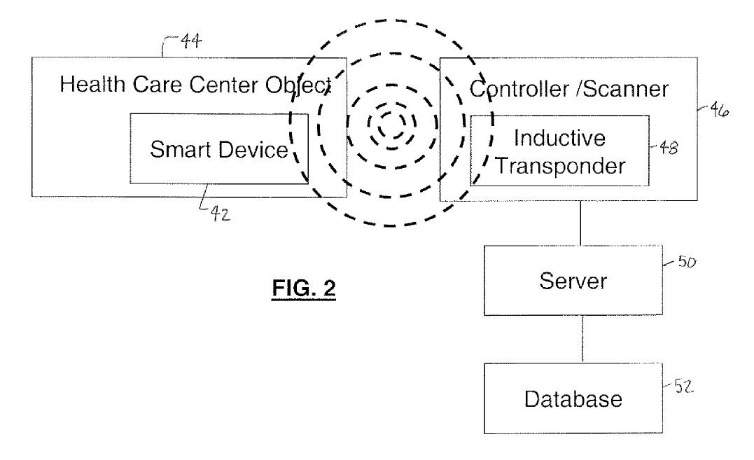

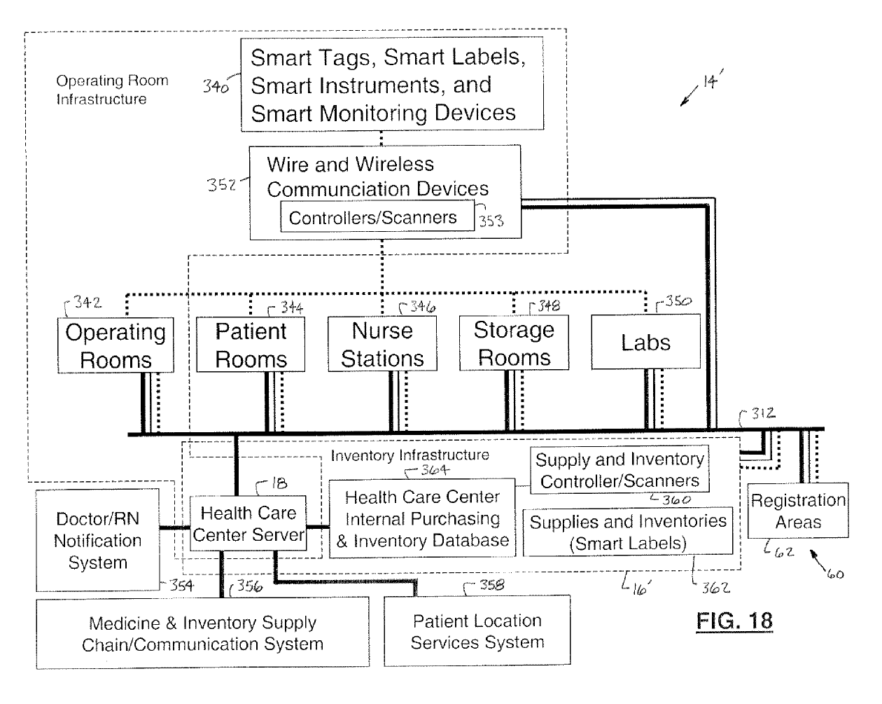

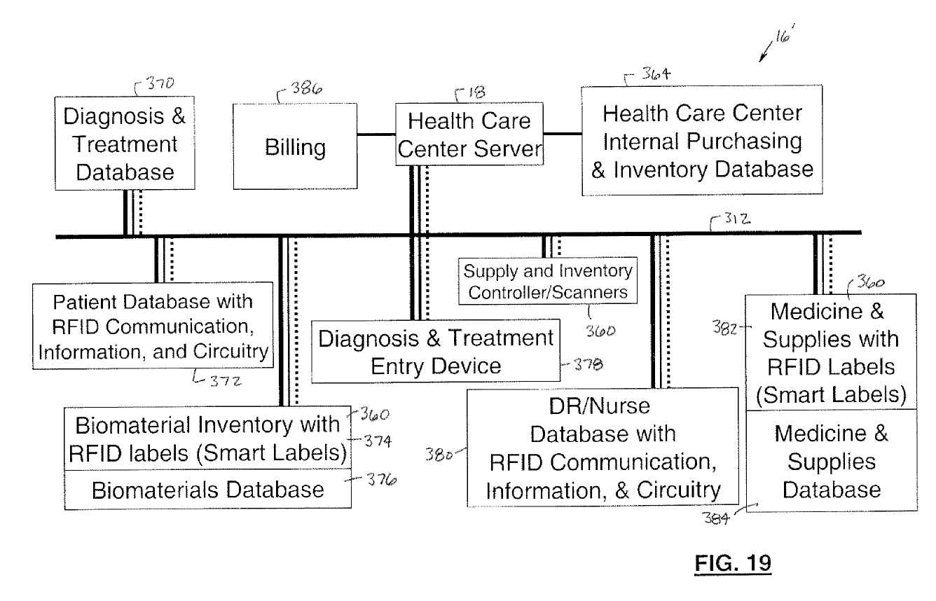

Referring now also to FIG. 2, a block diagrammatic view of a sample generic smart device sub-system 40 is shown in accordance with an embodiment of the present invention. The smart device sub-system 40 is shown for simplification reasons and may be modified and referred to as a smart tag sub-system, a smart label sub-system, a smart instrument sub-system, or a smart monitoring device sub-system. The smart device sub-system 40 includes one or more smart devices 42 (only one is shown), which are attached to one or more health care center objects 44 (only one is shown). A controller/scanner 46 writes information to and/or reads information from the smart devices 42 via electromagnetic induction and radio frequency wireless communication. The information is communicated between the smart devices 42 and a server 50 and is stored on the smart devices 42 and the database 52. The server 50 and the database 52 may be one-in-the-same as the server 18 and the database 20 or separate and in communication therewith. Each of the sub-systems may share a single server and database or may have associated servers and databases. Incorporated examples of using multiple databases are shown with respect to FIGS. 18 and 19.

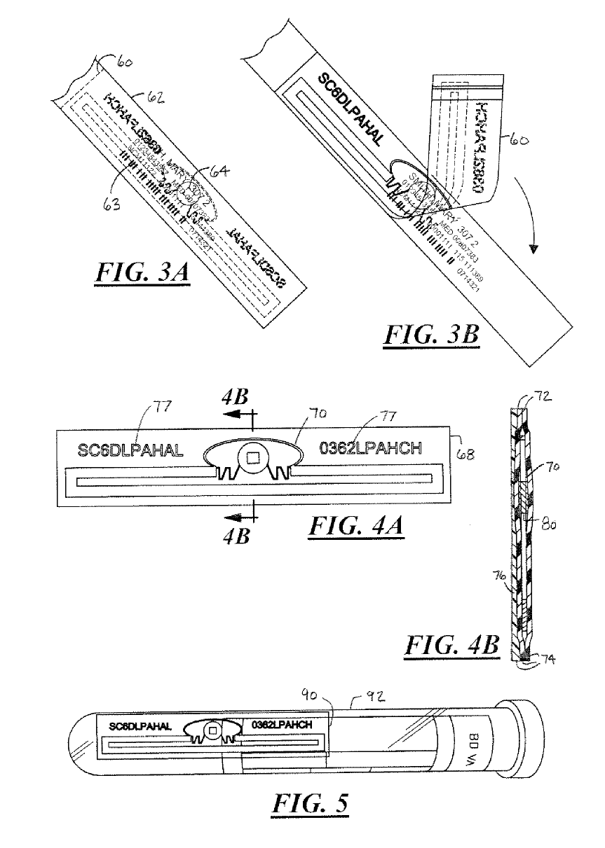

The smart devices 42 may be in the form of smart tags 27, smart labels 29, smart instruments 31, and smart monitoring devices 33, which are all described in further detail below. The smart devices 42 may utilize radio frequency identification (RFID) or inductive transponder technology for communication. The smart devices 42 receive electromagnetic waves from the controller/scanner 46, which they draw power therefrom and in response thereto inductively generate identification signals. The smart devices 42, as shown and as primarily described below, are passive and thus do not have an associated power supply or battery rather they respond using energy received from an inductive transponder within the controller/scanner 46. However, in one embodiment of the present invention, the smart devices 42 are semi-passive and utilize power from a power source (not shown) for chip or circuit operation and utilize power drawn from the electromagnetic waves to respond to the inductive transponder 48. The smart devices 42 may be read only or read/write. Example smart devices are shown and described with respect to FIGS. 3-11.

Referring now also to FIGS. 3A and 3B, front views of a smart tag 60 as applied to patient identification band or bracelets 62 are shown in accordance with an embodiment of the present invention. Of course, the smart tag 60 may be applied to patient tag, badge, or other patient item that temporarily or permanently remains with the patient and that can be used for identification purposes. The bracelet 62 has a traditional barcode 63. The combination of the smart tag 60 and the barcode 63 creates a smart non-localized identification of the patient and patient information. The barcode 63 may be utilized or replaced by the smart tag 60.

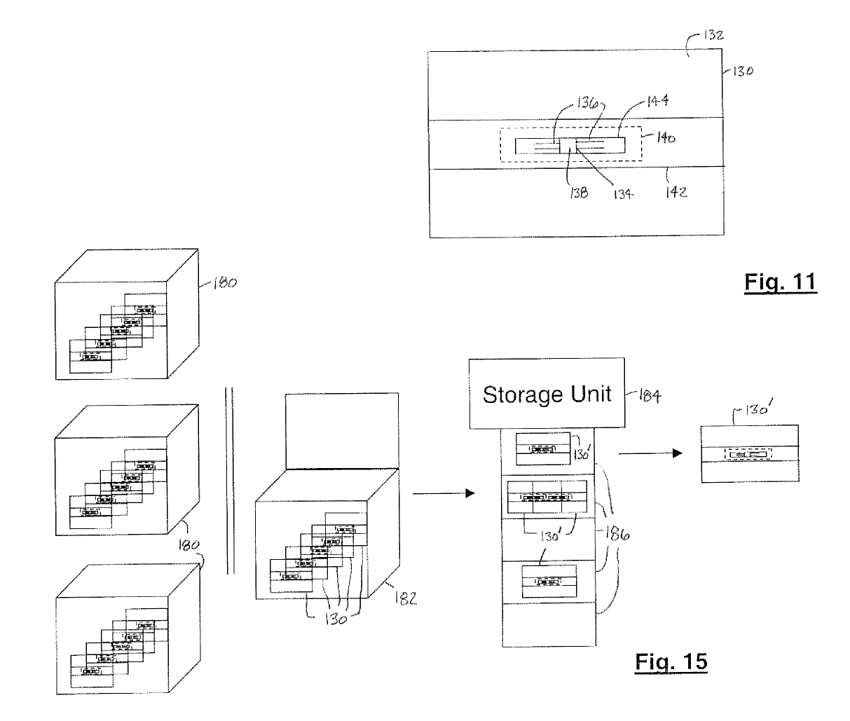

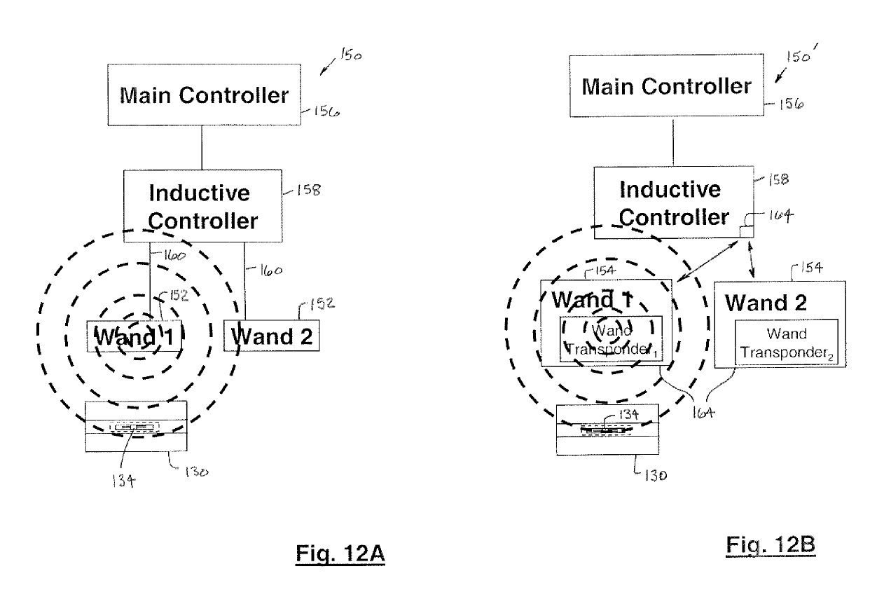

The smart tag 60 has an associated smart tag system, such as the smart device system 40. The smart tag system, is directed to patient registration, identification, history, and location detection information, as well as other known patient related information. The smart tag 60 contains a radio frequency based smart body internal control circuit 64; such a circuit is described below with respect to FIG. 11. The smart circuit 64 is attached to or embedded within the smart tag 60 and stores information associated with a patient. Likewise, the smart tag 60 may be attached to, on an interior side, on an exterior side, or embedded within the bracelet 62.

The health care operating system 10 in conjunction with the smart tags provides a complete system architecture that tracks a patient from the point of admission to a hospital, medical center, or other health care center to the point of discharge. A registration system 60 is used at admission, which records currently stored database information pertaining to the patient in a smart tag, which is attached to the patient. The registration system 60 stores all prior medical procedures, correlates all biomaterials, medicines, and authorized medical procedures on the smart tag. Thus, all of the stated information is carried with the patient.

The registration system 60 includes controller/scanners (not shown for simplicity), which are similar to the controller/scanner 46 and other controller/scanners described herein. The controller/scanners are located in registration areas 62 and write the above-stated information to the smart tags 27. The registration system 60 and areas 62 are shown in FIG. 18. The registration areas 62 may include emergency or general entrance areas, areas within or in proximity of an ambulance or other health care center associated vehicle, registration table areas, nurse station areas, or any other areas within or in proximity of a health care center.

The smart tags 27 are encoded with all pertinent patient information (e.g., name, allergies, symptom) at the time of patient registration. During the patient's stay at the health care center, the smart tags 27 uniquely identify patients and any procedures or medications that are to be administered to the patients. Incorrect procedures are detected, through the use of smart software, and the proper health care center personal are notified. Smart software, in general, refers to the software utilized by any of the controllers, scanners, servers, or other devices described herein. This reduces the potential for incorrect treatment and possible complications.

The smart tags 27 may be active, semi-passive, or passive and be scanned or monitored throughout the health care center via controller/scanners described herein or other designated monitoring stations (not shown). The controller/scanners and monitoring stations may be active or passive in that they may induce or request signals from the smart tags or they may simply receive signals from the smart tags. The monitoring stations may be located anywhere within the health care center, in communication with the server 18, and have similar scanning capabilities as the stated controller/scanners. The smart tags 27 may be monitored and/or detected within a range of approximately 0-10 ft, depending on the style of smart tag, up to approximately 2 ft when passive and approximately up to 10 ft when active. The smart tags 27 may be used with health care center accounting in order to accurately account for procedures and costs associated with patient treatments, as well as “just-in-time” ordering of supplies for the health care center.

The smart label sub-system, is similar to the smart tag sub-system, however biomaterial and medicine containers, as well as various other containers, which may or may not be associated with the patient are labeled using the smart labels 29. The smart labels 29 are similar to the smart tags 27, are attached to the containers, and store information that is patient related and/or that pertains to that object and the location thereof. One or more of the smart labels 29 may be used per container. The smart labels 29 may be referred to as a form of RFID labels. The biomaterials may include blood, sputum, urine, cell samples, fluid samples, or other biomaterials known in the art. A smart label can be used on any health center container and is generally extensible to other objects including, but not limited to, clothing, bedding, wheel chairs, and other inventory items. Inventory control and location determination can be achieved through use of the smart labels 29.

Referring now to FIGS. 4A and 4B, perspective and side views of a smart label 68 are shown. The smart label 68 includes a smart control circuit 70, similar to the control circuit 64. The smart circuit 70 is attached to or disposed between multiple layers of material 72. The smart circuit 70 may be in effect laminated between two laminating layers of material 74 as shown. The material layers 72 may be flexible such that they are compliant to various shaped portions of an object and easily attached thereon. The material layers 72 may include one or more adhesive layers 76 (only one is shown) for the attachment to healthcare center objects. The material layers may have identification codes 77 printed or engraved thereon.

The smart circuit 70 includes a transponder 78 and a logic circuit 80. The transponder 78 and the logic circuit 80 may be encased within a hypoallergenic casing; a sample hypoallergenic casing is shown in FIG. 11. The material layers 72 may form the hypoallergenic casing. The transponder 78 allows for communication transfer of the identification information stored in the logic circuit 80. The hypoallergenic casing is used to prevent allergic reactions.

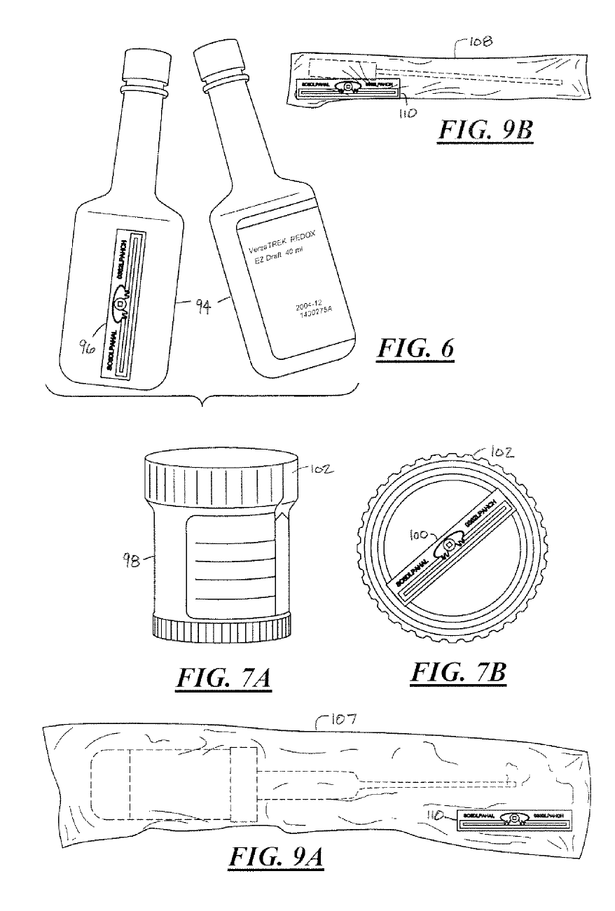

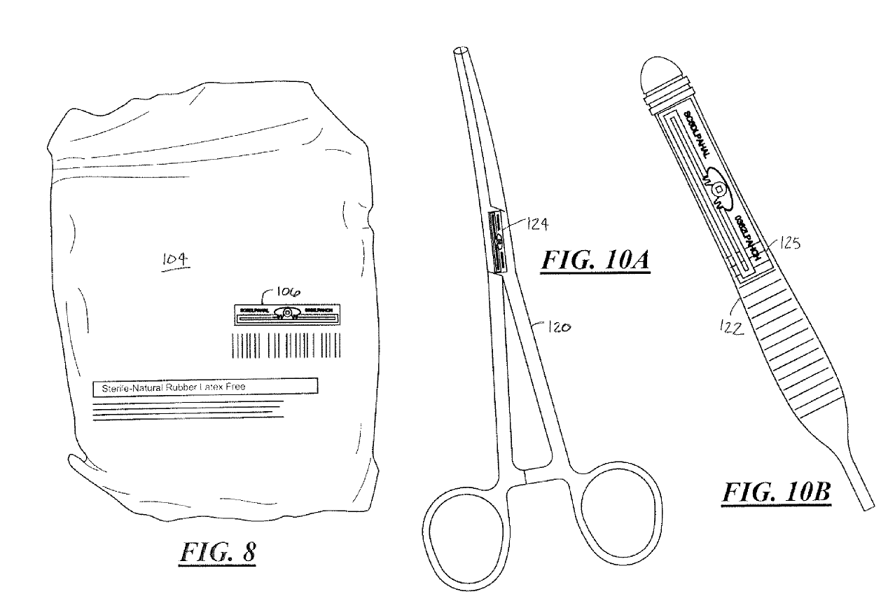

Referring now to FIGS. 5-9B, example illustrative views of containers with smart labels attached thereon are shown. FIG. 5 shows a close-up perspective view of a smart label 90 on a vacutainer 92. FIG. 6 shows a perspective view of another container 94 having a smart label 96 attached thereon. FIGS. 7A and 7B show perspective views of a specimen container 98 having a smart label 100 attached on the lid 102 of the container 98. FIG. 8 shows a front view of a towel container 104 having a smart label 106 attached thereon. FIGS. 9A and 9B show perspective views of a specimen trap container 107 and a culture swab containers 108, which may have smart labels 110 attached thereon. Smart labels may also be on the specimen trap and the culture swab themselves, although not shown.

Referring again to FIG. 1, the smart labels 29 may also be used on gurneys, various other equipment, and the materials placed thereon. The smart labels 29 may be utilized on any moveable or non-moveable device. The smart labels 29 may be used on patient belongings, charts, towels, blankets, pillows, and various other items. A gurney and everything on that gurney may be scanned prior to leaving a given area and rescanned upon entering a destination to assure accountability for each item on that gurney.

RFID labeling of patients and related containers provides a correlation therebetween, which reduces the failure modes associated with incorrect container and patient mismatching. Blood type, allergies, and other patient characteristics are uniquely identified and may be stored on a smart tag and/or smart label for each patient. In addition, the treatment record and scheduled procedures of a patient may also be stored to ensure that the patient gets the proper treatment. Any smart tags and smart labels of concern may be scanned and/or information therein may be received and reviewed prior to any treatment. Smart tags and smart labels may be scanned and/or data may be received therefrom wirelessly, without the need of a manual scanning (barcode) or manual data entry system, and this data may be recorded and linked to a health care center server.

The health care operating system 10 also includes a smart docketing system 26, a smart x-ray system 28, a smart alarm system 30, and smart procedure system 32, which are all described in detail below with respect to phases two and three. The stated systems utilize the servers, databases, controllers, scanners, smart tags, smart labels, smart instruments, and smart monitoring devices described herein. The smart software, utilized in the systems, may have associated modules that correspond with each of the systems.

In general, the scanning and retrieving technology to read and write information to the smart tags 27 and the smart labels 29 is referred to as the smart docketing system 26. In one example embodiment, depending on the procedure of a patient, the smart docketing system 26 reads a smart tag located on that patient. Given the patient information, the smart docketing system 26 wirelessly writes at least a portion of the patient information onto one or more of the smart labels 29 that uniquely identifies the patient with any associated biomaterials, medicines, or surgery or patient room items.

After completion of the first phase in which health care center objects are uniquely correlated with a patient the second phase is initiated. The second phase involves the testing and recording of the patient and health care center objects in an automated method so as to reduce false patient diagnosis and treatment. The smart docketing system 26 is again utilized throughout testing, such as in testing laboratories, to quickly and efficiently scan and identify any material containers or holding elements. The smart docketing system 26 may also be used to scan and identify x-ray cartridges or the like, vial/containers, or any other health care center objects associated with a particular patient. The information obtained is then recorded using the smart software and stored and accessible through use of the health care center server 18.

The smart docketing system 26 can be used to ensure that a patient receives the proper medicine, treatment, and procedure through the use of a complete IT solution that integrates the use of smart tags, smart labels, and the smart docketing system 26. The IT solution may include the use of an Internet or Intranet system. The smart software may be accessible through the use of the health care center server 18, may be located on the server 18, may be located on any computer system, controller, scanner, or circuit within the health care center system 10 network or that is networked to or has access to the health care center operating system 10. This includes computer systems or terminals that utilize wire, powerline, and/or wireless communication.

During phase two a patient may undergo various scanning or x-ray procedures. During such scanning, x-ray cartridges or the like may be utilized, which contain x-ray images of the patient. The smart x-ray system 28 utilizes and attaches a smart label to the x-ray cartridge, which is not shown, but may be considered as one of the health care center objects. The smart x-ray system 28 scans the patient RFID and then transfers this ID to the smart label on the x-ray cartridge. The x-rays are taken and upon entry into an x-ray digitizer, the patient information is transferred to the digital imager so as to uniquely identify the x-rays with the patient. This process is especially advantageous when multiple or a batch of x-ray images are taken. X-ray films are typically processed in a batch process so that multiple x-ray images are digitized well after the patient has left the x-ray lab. Consequently, this system improves the accuracy of patient-film matching, as well as improves the efficiency of the imaging process. Once an x-ray cartridge has been removed from a digitizer and the x-ray data contained therein has been stored, the cartridge RFID may be erased and reused for the next patient.

After a treatment and/or procedure has been determined the third phase may be initiated and the treatment and/or procedure is performed. Another sub-system, referred to as the smart procedure system 32, is utilized and includes the use of the smart alarm system 30, the smart monitoring devices 31, and the smart instruments 33. Although the smart alarm system 30 is described primarily with respect to the third phase, it may also be used in other phases and in a different capacity.

The smart instruments 31 include surgical fluid absorbing apparatuses, as well as other surgical apparatuses that may be used throughout an operation of a patient. Some of the instruments 31 may be used to aid in the facilitation of an operating procedure. The smart instruments 31 also include a radio frequency circuit, which may be similar to that used on the smart tags 27 and the smart label 29. Each smart instrument 31 may store data associated with the procedure being performed, as well as patient identification information.

The smart instruments 31 may include fluid absorbing apparatuses, surgical equipment or tools, and other instruments known in the art. Surgical equipment may include for example a scalpel, a retractor, a pair of pliers or tweezers, or other known equipment. FIGS. 10A and 10B show side views of a pair of pliers 120 and a pair of tweezers 122 that have a micro RFID label 124 and an RFID label 125, respectfully. Micro RFID labels are similar to the RFID labels, but are smaller in size. Each surgical instrument is labeled with a micro RFID label and is accounted for by an RF scanning technology before and after the operation. Also, a correct list of instruments needed for the particular procedure may be reviewed. When a particular instrument is missing or a surplus or unneeded instrument is detected the alarm system 30 may generate an alarm signal.

The smart monitoring devices 33 may also be in the form of equipment and are used throughout and monitor a treatment or operating procedure. The smart monitoring devices 33 may include RFID labels or controllers that have stored patient and procedure identification information and additional logic. The additional logic may be used to monitor the operation of the smart monitoring devices 33 and other procedure parameters. The smart monitoring devices 33 may include and/or monitor, for example, the operation of pumps, ventilators, EKGs, sequential compression devices, the blood or medication being administered, fluid flow rates, and other devices and parameters. The smart monitoring devices 33 may monitor the procedure being administered and the use of the smart docketing system 26 to wirelessly scan a smart tag of a patient to determine whether the procedure is appropriate and is being administered accurately, as well as to determine whether associated parameters are within desired, predetermined, or recommended ranges. Proper and accurate medications and procedures are enabled through the use of the stated devices.

The smart alarm system 30 is generally used as part of the operating system 10 to alert health care center personnel when an instrument is missing, when a treatment and/or procedure is being improperly administered, or a parameter error exists. Utilizing RFID tagging and labeling, the smart alarm system 30 is employed to ensure that the patient receive the appropriate care that has been prescribed for that patient. Patient rooms, operating rooms, or medical treatment areas are instrumented with RFID scanning technology, which supports the reading of the stated information. Upon reading the RFID information concerning the patient from the smart tags 27, smart labels 29, smart instruments 31, and smart monitoring devices 33 in the collocated treatment area, an alarm signal is generated when a discrepancy is observed. The alarm signal involves several components that involve audible and visual warnings. An alarm signal may be sent to the assigned doctors and/or nurses in charge or any support personnel listed in the alert database.

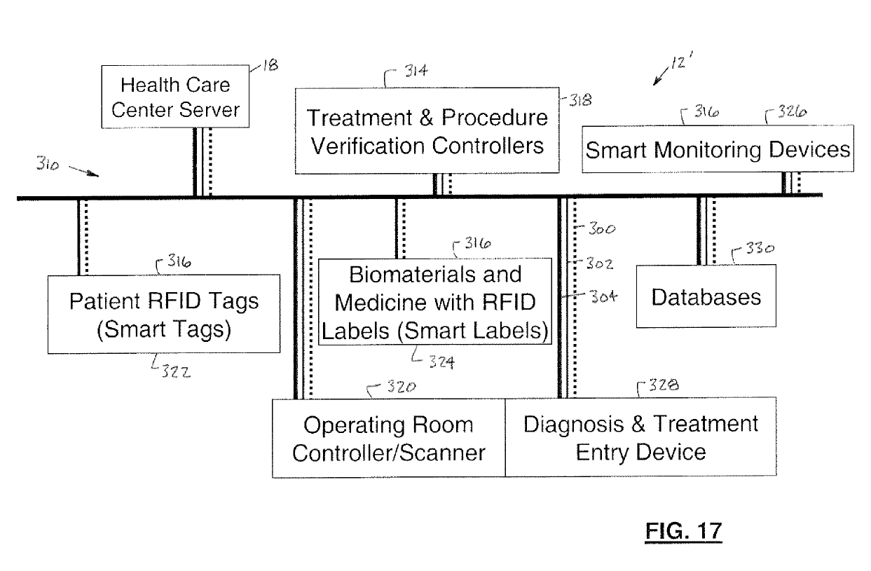

As an example use of the smart procedure system 32, prior to an operation, a surgical tray may be scanned whereby each instrument on the tray is identified and stored into a smart instrument database, such as one of the databases 330, shown in FIG. 17. The tray and each instrument may have a RFID label or smart label. During this query procedure, the patient information (or any other type of pertinent information such as operating room number, surgical procedure information, and doctor and nurse identifications) may be written and stored on each smart instrument RFID label. During the operation the smart monitoring devices monitor the above-stated parameters and generate an alarm signal when appropriate. After the operation, the tray is scanned a second time, whereby, each instrument is accounted. When an instrument is missing, in other words, is not on the tray, an alert or alarm signal is generated. The operating room staff can manually scan the patient using a RFID scanning wand in order to identify whether the missing instrument is within the patient and the approximate location of the missing equipment. As an alternative or in addition thereto and upon generating the alarm signal a physical search of the area or patient may be performed. Once the instrument has been located, and placed on the tray, the instrument is accounted for and the system returns to normal status. Thus, the smart procedure system tracks and accounts for all surgical equipment utilized in the procedure.

Tracking and accounting for all surgical equipment reduces costs and improves operating room efficiency. This wireless technological breakthrough not only helps to automate and improve operating room efficiency but it helps to reduce follow-up surgical treatment for unaccounted for instruments.

The above-stated technology may also be used to track health care center objects that are unrelated to a particular patient. The stated technology may be used in shipping and receiving, in stocking of objects, or in other areas of a health care center. For example, in shipping and receiving areas supply and inventory databases may be updated accordingly with respect to any object that is leaving from or arriving to the health care center.

The following FIGS. 11-16 provide example descriptions and implementations of surgical apparatuses. Although FIGS. 11-16 are primarily described with respect to fluid-absorbing apparatuses, the present invention may be applied to any surgical apparatus. Some example surgical apparatuses are an operating instrument, a utensil, a tray, a gurney, a pair of pliers or tweezers, a scalpel, or some other surgical apparatus known in the art.

Referring now to FIG. 11, a block diagrammatic view of a smart fluid absorbing device 130 for use during an operating procedure is shown in accordance with an embodiment of the present invention. The smart device 130 includes a surgical fluid absorbing apparatus 132 and a smart control circuit 134. The smart circuit 134 is attached to the absorbing apparatus 132 and stores identification information. The smart circuit 134 may be located anywhere on or embedded anywhere in the absorbing apparatus 132. As implied above although the smart circuit 134 is applied to the absorbing apparatus 132, it may be applied to any surgical apparatus known in the art.

The absorbing apparatus 132 may be of various types, styles, sizes, and shapes. The absorbing apparatus 132 may be in the form of a cloth, a sponge, a towel, a pad, a swab, or other fluid absorbing apparatus known in the art. The absorbing apparatus 132 may be formed of various materials, such as cotton, gel, foam, thermoplastic, synthetic resin, natural rubber, synthetic rubber, cellulose, and nylon, or may be formed of some other material or material composite known in the art. The absorbing apparatus 132 may be packaged in groups, such that more than one fluid absorbing apparatus is contained within a single package. In one embodiment of the present invention, the fluid absorbing apparatuses are packaged in groups of five, as is shown in FIG. 15 and as described further below.

The smart control circuit 134 includes a transponder 136 and a logic circuit 138. The transponder 136 and the logic circuit 138 may be encased within a hypoallergenic casing, as is designated by dashed lines 140. The casing 140 is attached to a radio opaque marker or strip 142. The transponder 136 allows for communication transfer of the identification information stored in the logic circuit 134. The hypoallergenic casing 140 is used to prevent allergic reactions. During production of the smart device 130 the logic circuit 134 and the transponder 136 are mounted on the backing board 144, encased in the casing 140, and attached to the strip 142.

The transponder 136 may be in the form of an antenna and used to receive inductively generated identification signals containing identification information. The identification information may include an identification number or code that is designated for that particular smart device. Before use of the smart device 130 in an operating procedure, the identification information may be stored on the logic circuit 134 and periodically scanned to perform an accounting of all fluid absorbing devices used during that procedure. The term “accounting” refers to the difference between the number of fluid absorbing devices actually in use and the number of fluid absorbing devices accounted for, which includes the fluid absorbing devices that are registered for use, are in use, and have been removed and/or discarded after use.

The logic circuit 134 may be a solid-state silicon based circuit or may be in some other form known in the art. The logic circuit 134 may be read or written to using radio frequencies. The use of radio frequencies to communicate identification information regarding smart fluid absorbing devices may be referred to as radio frequency identification (RFID) or inductive transponder technology.

The backing 144 may be formed of a high temperature resilient material such that it is capable of withstanding temperatures required for sterilization. Sterilization temperatures for fluid absorbing devices can exceed 105° C.

Although a hypoallergenic casing is utilized, other casings may be used. The hypoallergenic casing 140 may be attached to the strip 142 via an adhesive, may be stitched to the fluid absorbing apparatus 132 or the strip 142, or may be attached using some other attachment technique known in the art.

Referring now to FIGS. 12A and 12B, block diagrammatic views of smart fluid absorbing device detection and accounting systems 150 and 150′ are shown utilizing serially coupled transponder antennas 152 and wireless transponder antennas 154, respectively, in accordance with an embodiment of the present invention. The accounting systems 150 and 150′ include main controllers 156, inductive controllers 158, and one or more transponder antennas or wands, such as antennas 152 and 154. The main controllers 156 contain application software, such as for example the smart software. Through the use of inductive transponder technology each smart surgical fluid absorbing device 130 is registered prior to use and is rapidly accounted for after an operation through a deregistration process.

The wands 152 and 154 may be in the form of mobile handheld devices or may be in the form of stationary scanning devices. The serial coupled wands 152 are electrically coupled to the associated inductive controller 158 via serial connections 160. Each of the wireless wands 154 contains a wand transponder 162 that is in wireless communication with an inductive controller transponder 164 of the associated inductive controller 158.

The main controllers 156 and the inductive controllers 158 may be desktop or laptop configured or may also be in the form of handheld devices. In one embodiment of the present invention, the main controllers 156 are desktop configured and the inductive controllers 158 are handheld configured.

The main controllers 156 and the inductive controllers 158 may be microprocessor based such as a computer having a central processing unit, memory (RAM and/or ROM), and associated input and output buses. The main controllers 156 and the inductive controllers 158 may be in the form of application-specific integrated circuits or may be formed of other logic devices known in the art. The main controllers 156 and the inductive controllers 158 may be a portion of a central main control unit, may be combined into a single controller, or may be stand-alone controllers as shown.

The wands 152 and 154 transmit and receive the identification information to and from the logic circuits 134 located on the absorbing devices 130. The wireless configuration of the wands 154 simplifies the registration and deregistration process of the absorbing devices 130 by removal of the serial connections 160.

The wands 152 and 154 and the inductive controllers 158 may be in the form of low-power non-disruptive inductive devices that transmit and receive short messages. As such, the wands 152 and 154 and inductive controllers 158 do not affect a body of interest being acted on and also do not affect equipment utilized in the operating procedure. Since the accounting systems 150 and 150′ are inductive no power sources or toxic materials are utilized inside the body to enable communications between the wands 152 and 154 and the control circuits 134.

Although radio frequency identification with inductance is utilized, the accounting systems 150 and 150′ may be modified to support long-range detection for activation, registration, and deregistration of absorbing devices.

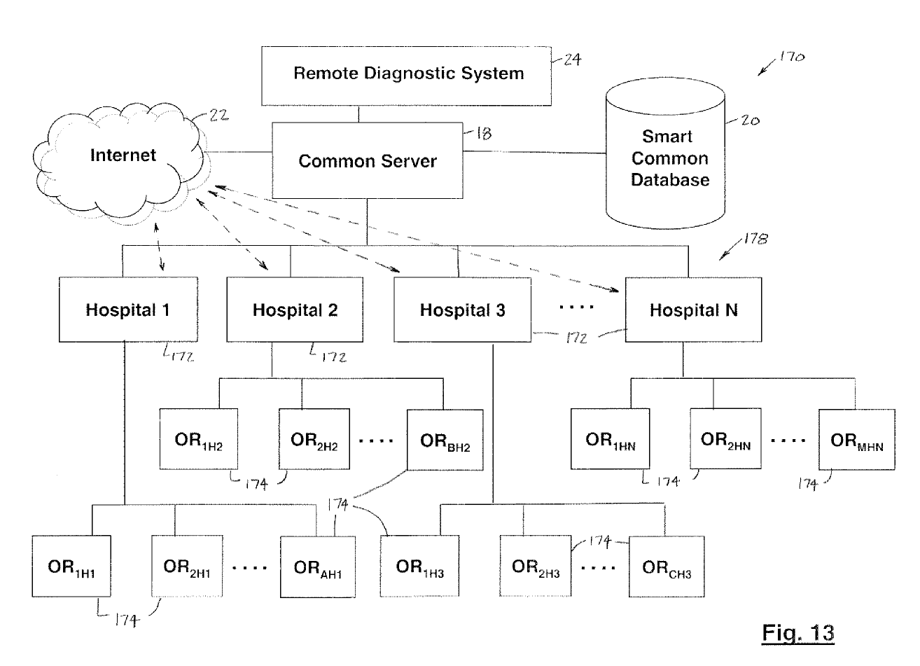

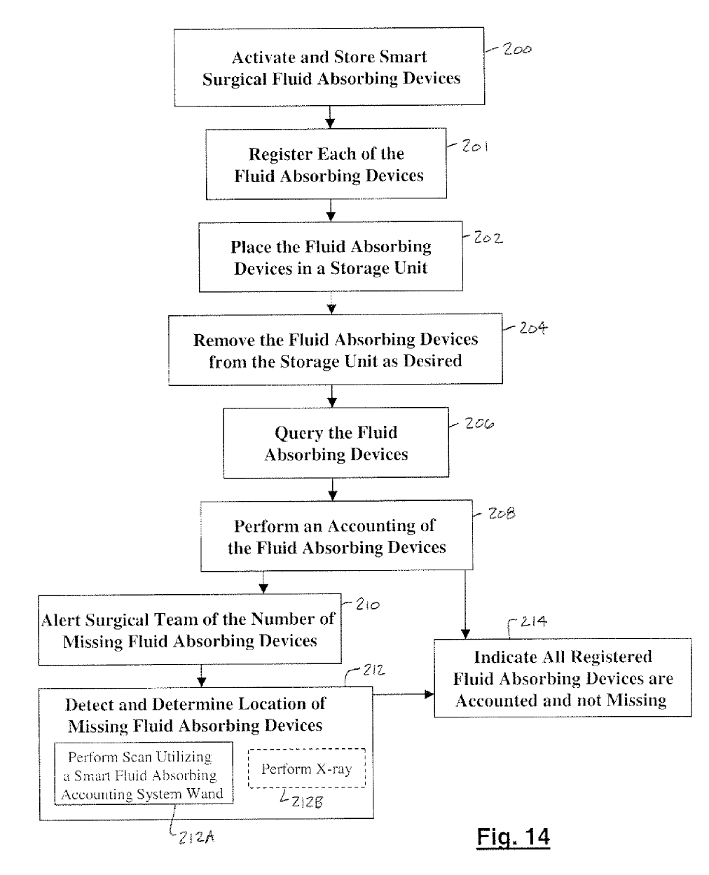

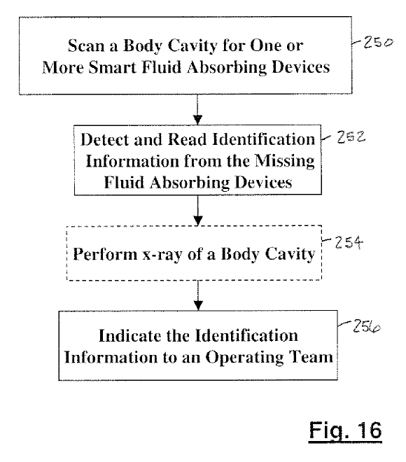

Referring now to FIG. 13, a block diagrammatic view of surgical fluid absorbing apparatus accounting network 170 in accordance with an embodiment of the present invention is shown. Since many hospitals have several operating rooms, which may each be used to perform various operating procedures twenty-four hours a day, network communications may be utilized. The accounting network 50 thus includes multiple hospitals 172 having any number of operating rooms 174, which each have access to the smart database 20 via the server 18. The operating rooms 174 may access the database 20 via an Intranet 178 or an Internet 22. There are N number of hospitals 172 and each hospital has an associated number of operating rooms. For example hospital₁ has A number of operating rooms. There are M sets of operating rooms, each set corresponding to a particular hospital.

The server 18 and the database 20 may be centrally located and within one of the hospitals 172. The smart database 20 contains identification information related to the smart absorbing devices 130 utilized in each operating room 174, which may be archived and retrieved at a future date. The database 20 may store information such as surgery type, number of smart absorbing devices 130 accounted for and used, and any other pertinent information to safe guard the accountability of the smart absorbing devices 130. The database 20 may also store a proposed or recommended radio frequency identification technique to be used in a particular operation such as for surgical equipment or tools. The database 20 may be accessed by hospital administrators and may be access limited to a certain set of hospital administrators.

The remote diagnostic system 24 ensures that the accounting network 170 and any accounting systems, such as systems 150 and 150′, function reliably. The remote diagnostic system 24 allows for remote administration of each hospital 172 and operating room 174. Remote administration provides a reliable real time surgical technique for management and accountability of smart absorbing devices. The diagnostic system 24 may also enable routine software upgrades and system performance enhancements. A technician may remotely access the accounting network 170 and determine the current status of the accounting network 170 and of any absorbing devices and accounting systems utilized therein. The remote diagnostic system 24 may be in direct communication with the server 18, as shown, or may be in communication via the Internet 22.

The server 18 the database 20, the Internet 22, the remote diagnostic system 24, the hospitals 172, and the operating rooms 174 may also communicate to each other wirelessly, via wire, or via powerlines. The server 18 the database 20, the Internet 22, the remote diagnostic system 24, the hospitals 172, and the operating rooms 174 may also communicate between each other through the server 18, through the Internet, or directly as desired. In one embodiment, all communication is performed through the server 18 such that the database 20 is continuously updated accordingly.

Referring now to FIGS. 14 and 15, a logic flow diagram illustrating a method of accounting for surgical fluid absorbing devices used during an operating procedure is shown along with a block diagrammatic view illustration of the transitions of the surgical fluid absorbing devices before use during the operating procedure.

In step 200, the smart fluid absorbing devices 130 that are to be stored and tentatively utilized during the operating procedure are activated. The absorbing devices may be activated via the wands 152 or 154. In FIG. 15, multiple packages 180 are shown, each of which having five smart fluid absorbing devices. Package 62 represents a package that is selected and thus initialized.

In step 201, a smart fluid absorbing apparatus detection and accounting system, such as accounting systems 150 and 150′, is used to register each fluid absorbing device 130 prior to use during the operating procedure. A wand, such as one of the wands 152 or 154, is passed over the package 182 and/or each of the fluid absorbing devices 130. The fluid absorbing device package 182 may be passed over or near the wand when the wand is in a stationary configuration.

The main controller 156 or inductive controller 158 assigns a unique identification (ID) for each absorbing device 130 and programs or writes that identification to each of the logic circuits 134. The ID can include an operating room number, surgical lead, patient name, operation type, an absorbing device number, as well as other identification information. In a simple example embodiment, a serially increasing fluid absorbing device number may be used as the ID.

In step 202, the absorbing devices 130 are placed within a storage unit or bin 184. The absorbing devices 130′ within the bin are registered. The bin 184 may be compartmentalized, as shown. Each compartment 186 may correspond to a particular type of absorbing apparatus. In step 204, the absorbing devices 130′ are removed from the storage unit 184 as desired for use during the operating procedure.

In step 206, as the absorbing devices 130 are used and removed from the body they may be returned to the storage unit 184 and scanned or they may be scanned and then disposed. Each absorbing device 130 is queried and read after the operating procedure. The absorbing devices may be queried during the operating procedure when it is desirable to dispose of an absorbing apparatus. The same wand may be used to query the absorbing devices during and after the operating procedure as that used to register the absorbing devices before the procedure.

In step 208, the main controller 156 compares the number of absorbing devices 130 that were registered and placed within the storage device 184 before the procedure with that existing in the storage device 184 during or after the procedure to assure that none of the absorbing devices 130 are unaccounted for or remain in the body cavity. When there exists a discrepancy between the number of absorbing devices registered and the number of absorbing devices existing during or after the procedure, the main controller 156 indicates to an operator, administrator, or other individual the discrepancy. Query time using the above-described technique is significantly reduced over that of prior techniques. Reduced query time reduces costs involved therein.

In step 210, when one or more fluid absorbing devices are not detected in step 208, but has been assigned as “used” during registration, the main controller 156 alerts the surgical team performing the operating procedure of the missing devices and there identification information. The surgical team may then proceed to perform an extensive search of the body to locate the missing absorbing devices. The accounting system utilized may message, request, or alert hospital staff for assistance. This messaging may be in the form of a text message. An administrator may initiate the alert.

In step 212, the missing absorbing devices are detected and location thereof is determined. In step 212A, the wand is used to detect the missing absorbing devices. The wand may be used to isolate the absorbing device within the body. Once detected the absorbing devices are removed.

The accounting system 170 may be configured to scan the storage unit 184 autonomously, in the form of a deregistration. Autonomous deregistration increases efficiency of the accountability procedure. When the absorbing devices are not stored within a storage unit, a manual deregistration process may be utilized. At the end of the operating procedure the absorbing devices that were initially registered for the operating procedure are compared to those deregistered. It may be the case that not all absorbing devices registered are used. Consequently any absorbing devices not used in the operation are deregistered and disposed. The disposal satisfies sterilization procedures.

In step 212B, an x-ray of the body may also be performed to detect the missing absorbing devices as desired. The opaque strip of the absorbing devices may be detected through the use of an x-ray machine.

In step 214, when all of the absorbing devices registered are accounted for the main controller 156 indicates such to the operating team. Any missing absorbing device alerts are deactivated and operating room data is stored in a database, such as the database 20.

The alerts in steps 210 and 214 may be audio and/or video in nature. The alerts for a missing absorbing device may have an alarming sound and/or visual graphic warning indication. The alert that all absorbing devices registered are accounted for may have a pleasant sound and/or visual graphic indication.

Referring now to FIG. 16, a logic flow diagram illustrating a method of detecting at least one surgical fluid absorbing device within a body cavity is shown.

In step 250, the body cavity is scanned using as an example one of the above-described wands and accounting systems. In step 252, when an absorbing device is detected the accounting system reads the identification information stored on the control circuit of that absorbing device and generates an identification signal. In step 254, an x-ray of the body cavity may also be performed to further aid in the detection and location determination of the absorbing devices.

In step 256, an accounting system, such as one of the accounting systems 150 and 150′, generates an identification signal in response to the identification information and indicates to the operating team the detection of the absorbing device and any related identification information.

The above-described steps with respect to the methods of FIGS. 14 and 16 are meant to be illustrative examples; the steps may be performed sequentially, synchronously, simultaneously, or in a different order depending upon the application.

Referring again to FIG. 1, the operating system 10 includes a wireless infrastructure including the RFID tags 27 and labels 29 described above and may also include a wire infrastructure and a powerline infrastructure. The infrastructures 12, 14, and 16 may utilize powerline communication, wireless machine-to-machine protocol, wireless communication including wi-fi and cellular communication and wireless modems. The infrastructures 12, 14, and 16 may also include other wire, powerline, and wireless communication systems and protocols known in the art. A sample model of the communication and the infrastructures 12, 14, and 16 is shown in FIGS. 17-19. Wireless communication links 300 are represented by dashed lines, wire communication links 302 are represented by thin solid lines, and powerline links 304 are represented by thick solid lines. The communication infrastructures couple the smart tags 27, smart labels 29, smart instruments 31, and smart monitoring devices 33 to each other and to other health care center systems to ensure that data reaches the health care center servers, doctors, and any support staff for timely and accurate treatment of patients. The infrastructures 12, 14, and 16 are also in communication with each other.

In FIG. 17, a sample operating room infrastructure 12′ is shown. The infrastructure 12′ includes a communication network 310 with a backbone or main data communication line 312. The communication line 312 may be replaced or used in conjunction with a main wireless distribution center (not shown). The health care center server 18 is in communication with various controllers/computers 314 and other RFID devices 316. Some of the controllers and RFID devices are shown and include treatment and procedure verification controllers 318, operating room controller/scanner 320, smart tags 322, and smart monitoring devices 326, as well as smart labels, such as those on the biomaterials and medicines 324. Biomaterials, medications, and procedures are uniquely assigned and known for each patient given the RFID technologies contained herein. The operating room controller 320 may be in the form of a stand-alone computer or scanner or may be in the form of a handheld scanner and data entry device 328, such as a personal data assistant system, that wirelessly communicates to the server 18 via the main line 312. The operating room infrastructure 12′ may also include various databases 330, some of which are described herein, as well as other communication devices.

In FIG. 18, a sample health care center infrastructure 14′ is shown. The health care center infrastructure 14′ includes the main line 312 and the health care center server 18. The main line 312 is in communication operation with various rooms, labs, and stations of the health care center, as well as to various smart devices 340. The main line 312 is in communication operation with controllers and devices located in, for example, operating rooms 342, patient rooms 344, nurse stations 346, storage rooms 348, and labs 350. The smart devices 340 may be in direct wireless communication with the main line 312 or in wire or wireless communication with the main line 312 via various wire and wireless communication devices 352, some of which are mentioned herein. The wire or wireless communication devices 352 may be separate from the smart devices 340, as shown, or may be included as part of the smart devices 340. Although the smart devices 340 are primarily shown as being part of the health care center infrastructure 14′, they may also be part of other infrastructures, such as the inventory infrastructure 16′ and utilized within the patient rooms 344, the nurse stations 346, the storage rooms 348, and the labs 350. The communication devices 52 include controllers/scanners 353, such as the controller/scanners 46, 156, 158, and 320.

The health care center server 18 is also in communication with a doctor/resident nurse (RN) notification system 354, a medicine and inventory supply chain/communication system 356, and a patient location services system 358. The server 18 is in addition coupled within the inventory infrastructure 16′. The notification system 354 is used to notify or alert doctors and nurses of upcoming and ongoing treatments and procedures and the status thereof. The medicine and inventory communication system 356 provides external access for the ordering of medicines and supplies. The patient location services system 358 aids in the locating of a patient within a health care center through detection of an associated smart tag.

A portion of the inventory infrastructure 16′ is shown in FIG. 18 and includes supply and inventory controller/scanners 360, supplies and inventories 362 with smart labels, and a health care center internal purchasing and inventory database 364. As supplies and inventory are received, shipped, used, removed, depleted, and/or translocated, the controller/scanners 360 are used to update the inventory database 364. The inventory infrastructure 16′ is described in greater detail with respect to FIG. 19.

In FIG. 19, the sample inventory infrastructure 16′ is shown. The inventory infrastructure 16′ also includes the main line 312 and the health care center server 18. The inventory infrastructure 16′ includes the inventory of materials and supplies with RFID identification for each, as well as other controllers, databases, and systems. The inventory infrastructure 16′ includes a diagnosis and treatment database 370 with stored treatment and procedure information, which may or may not be associated with each patient. The diagnosis and treatment database 370 may include guidelines, information, and parameters associated with each of the treatments and procedures. A patient database 372 includes any information associated with a patient including history, identification, and treatment and procedure information.

The inventory infrastructure 16′ also includes a biomaterial inventory 374 and a biomaterials database 376. A biomaterial inventory 374 includes the biomaterials of each patient and other biomaterials. The biomaterials are stored in various containers each having a smart label. A biomaterials database 376 may be utilized to store biomaterial related information and inventory status of the biomaterials 374. The biomaterials may be associated or assigned with patients or may be in the form of a stored inventory supply, which is to be assigned.

A diagnosis and treatment entry device 378, such as device 328, may be incorporated into the inventory infrastructure 16′ for the entering of data related to a diagnosis or treatment, as well as for other patient, inventory, and health care center related information.

A doctor/nurse database 380 is also included and stores doctor and nurse information and identification associated with each treatment and procedure and for each patient. For example, the names of the doctors and nurses that were assigned and that actually performed a particular treatment or procedure for a particular patient is stored and associated therewith for future access.

A medicine and supplies inventory 382 is further included along with an associated database 384. The containers within the supplies inventory 382 also have RFID labels. The medicine and supplies database 384 operates in conjunction with the medicine and inventory communication system 356. The medicine and supplies may also be associated or assigned to patients or may be in the form of a stored inventory supply, which is to be assigned.

The inventory infrastructure 16′ also includes a billing system 386. The billing system 386 performs accounting services associated with each patient based on treatment and procedures performed, lengths of stay, medicines administered, supplies utilized, as well as other accounting factors known in the art. The billing system 386 may prepare bills based on the stated information.

The internal purchasing and inventory database 364 may include data contained in databases 370, 372, 376, and 384 for determining medicine and supplies needed for future treatments and procedures. The purchasing and inventory database 364 operates in conjunction with the medicine and inventory communication system 356 and the medicine and supplies database 384. The databases 364, 370, 372, 376, 380, and 384 may be separate as shown or combined into a single database. Automatic ordering of materials and supplies may be performed in response to the recorded inventories.

The medicine and inventory communication system 364 and the inventory infrastructure 16′ provide efficient ordering and stocking of materials and supplies and provide just-in-time delivery, which reduces inventory size, while maintaining proper supplies.

The infrastructures of FIGS. 17-19 may be used to determine when medication and supplies of a high priority are diminishing in inventory and generate an alarm signal to alert the appropriate personnel. Enhancements in operating efficiencies, and just in time medication and supplies are realized through the stated infrastructures.

The infrastructures may also be utilized to scan personnel and supplies as they travel between rooms and areas of the health care center. Identification of personnel, medicine, instruments, equipment, supplies, and other elements that are moved may be recorded for later evaluation and reference. This also aids in determining when, where, and the extent to which an item or product has been used.

The operating system may have detectors and scanners located throughout a health care center, which may be used to monitor and detect the smart tags, smart labels, smart instruments, and smart monitoring devices and may be coupled to the main line 312. Multiple health care centers and affiliated centers may be networked together and share one or more servers and common hubs such that the above information may be shared therebetween.

All above mentioned RFID control circuits, controllers, and computers may be in the form of logic circuits, may be in the form of solid-state silicon based circuits, or may be in some other form known in the art. The logic circuits may be read or written using radio frequencies. They may also be microprocessor based such as a computer having a central processing unit, memory (RAM and/or ROM), and associated input and output buses. They may be in the form of application-specific integrated circuits or may be formed of other logic devices known in the art. They may also be a portion of a central main control unit, may be combined into a single controller, or may be stand-alone controllers as shown. They may also include or be coupled to serially coupled transponder antennas and wireless transponder antennas.

The present invention provides a health care operating system that provide an efficient and easy to access tracking and accounting system for various health care center objects. The system and methods of the present invention are simple and inexpensive in design and may be used throughout a health care center and a health care center network.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A health care operating system comprising:
a plurality of health care center objects;
a plurality of smart devices coupled to said plurality of health care center objects and comprising a plurality of body internal control circuits;
at least one database storing information related to said plurality of health care center objects;
at least one server coupled to said at least one database; and
a plurality of controllers coupled to said at least one server and storing said information on said plurality of smart devices utilizing electromagnetic induction.

2. A health care operating system as in claim 1 wherein said plurality of health care center objects comprise at least one of a patient, a surgical apparatus, an absorbing apparatus, a surgical instrument, a biomaterial container, a medicine container, a stock container, an inventory/supply item, and a food/beverage container.

3. A health care operating system as in claim 1 wherein said plurality of smart devices comprise at least one of a smart tag and a smart label.

4. A health care operating system as in claim 1 wherein a combination of said plurality of health care center objects and said plurality of smart devices form at least one of a smart instrument and a smart monitoring device.

5. A health care operating system as in claim 1 wherein said plurality of controllers and said server communicate with each other via powerlines.

6. A health care operating system as in claim 1 wherein said plurality of controllers and said server communicate with each other wirelessly.

7. A health care operating system as in claim 1 further comprising a notification system coupled to said at least one server and alerting health care center personnel of treatments and procedures.

8. A health care operating system as in claim 1 further comprising an inventory supply chain/communication system coupled to said server and ordering supplies.

9. A health care operating system as in claim 8 further comprising a purchasing and inventory database coupled to said inventory supply chain/communication system and storing information pertaining to patients, diagnosis and treatments, biomaterials, medicines, and health care center inventories.

10. A health care operating system as in claim 1 further comprising a patient location services system coupled to said at least one server and locating a patient via a smart tag.

11. A health care operating system as in claim 1 wherein said plurality of smart devices inductively transmit communication signals to said plurality of controllers.

12. A health care center network comprising:
a plurality of health care center objects;
a plurality of smart devices comprising a plurality of body internal control circuits having information associated with said plurality of health care center objects, said plurality of smart devices inductively transmitting identification signals;
at least one database storing said information;
at least one common server coupled to said at least one database; and
a plurality of controllers within a plurality of facilities and in communication with said at least one common server in response to said identification signals.

13. A health care center network as in claim 12 further comprising an inventory infrastructure in communication with said at least one server.

14. A health care center network as in claim 12 wherein said plurality of facilities comprise an operating room, a patient room, a nurse station, a storage room, and a lab.

15. A health care center network as in claim 12 wherein said plurality of facilities comprise a plurality of health care centers.

16. A health care center network as in claim 12 further comprising a notification system, an inventory supply chain/communication system, and a patient location services system.

17. A health care operating system comprising:
a plurality of health care center objects;
a plurality of smart devices comprising a plurality of body internal readable control circuits having information associated with said plurality of health care center objects;
at least one database;
at least one server; and
a plurality of controllers coupled to said server and scanning and receiving said information from said plurality of smart devices using electromagnetic induction.

18. A health care operating system as in claim 17 wherein said plurality of controllers store said information in said at least one database via said at least one server.

19. A health care operating system as in claim 17 wherein said plurality of health care center objects comprises supply and inventory items, said plurality of controllers scanning said supply and inventory items upon reception and use thereof and updating said at least one database accordingly.

20. A health care operating system as in claim 17 wherein said plurality of smart devices are in wireless communication with said plurality of controllers via radio frequencies.
